(19) United States
(12) Patent Application Publication
(10) Pub. No.: US 2011/0000174 A1
(43) Pub. Date: Jan. 6, 2011

(54) RING FILTER ELEMENT

(76) Inventors: Klaus Kapelarie, Pischeldorf (AT); Stephan Mert, St. Michael (AT)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/595,419

(22) PCT Filed: Mar. 31, 2008
(86) PCT No.: PCT/EP08/53780

§ 371 Date: Aug. 20, 2010

(30) Foreign Application Priority Data
Apr. 10, 2007 (DE) 10 2007 017 091.4

(51) Int. Cl. B01D 46/24

(52) U.S. Cl. 55/492

(57) ABSTRACT

The present invention relates to a ring filter element (1), particularly a ring filter element (1) of an air filter for an internal combustion engine, having a filter body (2) comprising a filter material, and at least one sealing end disk (11) disposed on the face thereof. For this purpose an inner frame (4) is disposed on an interior peripheral surface (3) of the filter body (2) for reinforcing the filter body (2), wherein an inside diameter of the end disk (11) is at least as great as an inside diameter of the inner frame (4) such that the same is not covered radially toward the interior by the sealing material of the end disk (11).

The present invention relates to a ring filter element, in particular a ring filter element of an air filter for an internal combustion engine.

Such ring filter elements are used, for example, to filter out toxic suspended particles such as, for example, dusts from intake air in an internal combustion engine by means of which an improved combustion as well as less wear and tear of the internal combustion engine can be achieved. The ring filter elements have pure chamber and a crude chamber radially arranged within a filter body as well as a corresponding crude chamber or pure chamber arranged radially outside the filter body. In order to provide the stability required surrounding the filter body, which is customarily composed of filter material, a so-called inner frame is frequently provided on an interior peripheral surface of the filter body, said inner frame supporting the filter body. The inner frame can be configured as a supporting structure, in particular as a supporting grid manufactured out of plastic, and is axially embedded on the end-side in the end disc, which is configured as an axial sealing, on the front faces of the filter body, in particular foamed in. Since the sealing material of the end disc can frequently not be or only insufficiently connected to the material of the inner frame, a detachment of the sealing material from the inner frame arises, in particular in these regions, thereby negatively affecting the durableness of the ring filter element. Since the sealing material covers the inner frame in some locations only like a membrane, already minimal friction influences can lead to a detaching of the leak proof membrane from the inner frame.

The present invention addresses the problem of providing for an improved embodiment for a ring filter element, which embodiment is characterised in particular by an increased service life.

This problem is solved according to the invention by the subject matter of the independent claim 1. Advantageous embodiments are the subject matter of the independent claims.

The present invention is based on the general concept of insert moulding an inner frame of a ring filter element, which is arranged on an interior peripheral surface as well as on the axial front faces of a filter body of the ring filter element, with sealing material in only the region of the axial front faces of the filter body and embedding it therein; however, not in the region of the interior peripheral surface of the filter body. The end disc that is provided with an axial sealing is thus limited substantially on the front face of the filter body or on the front face of the ring filter element. In the region of the interior peripheral surface, an application of sealing material is limited to the regions between the webs of the inner frame. An interior diameter of the end disc in all regions is thus as large as an interior diameter of the inner frame, said inner frame, which can be configured as a supporting mesh in particular, thereby not being covered by sealing material in a radially inward direction or preferably in no location whatsoever. In this manner, a sealing membrane, which thinly covers the inner frame and poorly adheres thereto, is prevented, in a structurally simple manner, during the assembly or disassembly of the ring filter element from being from rubbed off or detached, thereby leading to the disconnection, at least in sections, of the connection between the end disc to the filter body. The end disc is thus configured of the material that seals the filter material.

It is advantageous that the inner frame has a ring that protrudes axially over the filter body, said ring being part of a radial step on the inner-frame side and that furthermore is embedded in an annular sealing lip by means of which the ring filter element can be more easily installed and sealed with regard to the filter housing. Since the sealing material of the end disc/axial sealing completely covers the ring that axially protrudes over the filter body, it does not come into contact with the filter housing, by means of which the sealing effect of the axial sealing could, in certain circumstances, be reduced. At the same time, the embedding of the part, which axially protrudes over the front face of the filter body, of the inner frame that is configured as a supporting structure offers the advantage that the supporting structure is solidly connected to the filter body of the ring filter element by means of the end disc/axial sealing. Since such end discs are customarily provided on both front faces, they can ensure a reliable connection of the inner frame to the filter body.

In a further advantageous embodiment of the solution according to the invention, the inner frame forms on the axial end of the filter body a radial step, in particular a step that is directed radially outward with the connecting ring in the axial direction of the ring filter element. By means of this configuration of the inner frame, said inner frame rests against the interior peripheral surface on the one hand, and, on the other hand, rests against both of the front faces of the filter body, by means of which it envelops the filter body on three sides at least partially in a “U”-shaped manner. In this manner, the inner frame is definitively determined with regard to its position on the filter body while, at the same time, relative movements between the filter body of the ring filter element and the inner frame are preferably entirely eliminated.

Additional important features and advantages of the invention can be found in the dependent claims, in the drawings and in the pertinent description of the figures with reference to the drawings.

It is understood that the features described above and those to be described in what follows can be used not only in the particular cited combination; but also in other combinations or independently without departing from the scope of the present invention.

Preferred exemplary embodiments of the invention are illustrated in the drawings and explained in greater detail in the description below.

It is schematically shown in

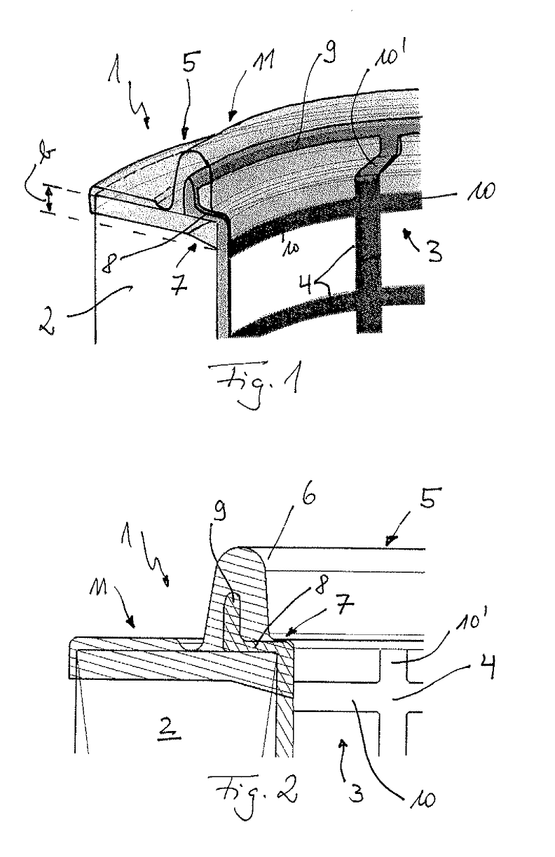

FIG. 1 a circular segment section of a ring filter element according to the invention,

FIG. 2 an illustration as in FIG. 1; however, in a detail view.

Corresponding to FIG. 1, a ring filter element 1 according to the invention has a filter body 2 as well as an inner frame 4 that is arranged on an interior peripheral surface 3 of the filter body 2 and is moreover configured as a supporting structure. The filter body 2 has filter material that is in particular capable of filtering out dust particles or similar impurities from a gas, in particular from air. Accordingly, the ring filter element 1 according to the invention is preferably used in an air filter for an internal combustion engine. According to FIGS. 1 and 2, only a circular segment section of the ring filter element 1 is illustrated that is otherwise not fully shown.

An end disc 11 is respectively arranged on at least one side of the front end side of the filter body 2, however preferably on both sides of the filter body 2, said end disc having an axial sealing 5. The end disc 11 as well as the axial sealing 5 is manufactured out of foamed plastic, for example out of polyurethane, and is impermeable with respect to a material that is to be filtered. As can be seen in FIGS. 1 and 2, the end disc 11 has a sealing contour, in particular a sealing lip 6, protruding in the axial direction of the filter body 2, said sealing lip being able to engage with a complementarily designed sealing groove, which is not shown, that is on a likewise unshown filter housing of the air filter. In order to reinforce the sealing lip 6 in the axial direction, the inner frame 4, which is configured in particular as a supporting structure or as a supporting grid, pulled over an axial end of the filter body 2 and is embedded in the sealing contour, respectively in the sealing lip 6 and enveloped by sealing material. The inner frame 4 thus protrudes in the axial direction over the filter body 2 and has the same radial step 7 at the axial end side. The inner frame 4 enlarges its interior diameter in this manner and rests with a bracket 8 against a front face of the filter body 2. A ring 9 is formed substantially orthogonally protruding from this bracket 8, thus here regarded from the axial direction of the filter body 2, said ring being part of the radial step 7 or the inner frame 4 and said ring furthermore being embedded in or foamed around the sealing material of the ring-shaped sealing lip 6 of the axial sealing 5.

Since only an insufficient or even no connection whatsoever can be made between the sealing material of the end disc 11 and the inner frame 4, in particular in the instance of a very thin moulding of the sealing material, an interior diameter of the end disc 11 is at least as large as an interior diameter of the inner frame 4 so that the inner frame 4 is covered radially inward in any location by the sealing material of the end disc 11. Although the sealing material of the end disc 11 is thus still arranged or applied on the interior peripheral surface 3 of the ring filter element 1 in regions, it is nevertheless limited to the regions between the individual webs 10 or 10′ of the inner frame 4. a thin membrane of sealing material can thereby be prevented from covering the webs 10, 10′. The main danger caused by a membranous covering is in the insufficient connection between the webs 10, 10′ and the sealing material, making it possible for the sealing material to become detached easily from the webs 10, 10′, by means of which the service life of the ring filter element 1 according to the invention is adversely affected.

The filter body 2 can, for example, be configured as a pleat star composed of zigzag-shaped, pleated filter web material the axial end of which in a region b is embedded in the sealing material of the end disc 11 or is encased therein or is insert moulded thereinto. In order to moreover be able to achieve a continually favourable sealing efficacy between the axial sealing 5 and a housing, which is not shown, the ring 9 is completely surrounded by sealing material.

1. A ring filter element of an air filter for an internal combustion engine, comprising:
a filter body comprising a filter material,
at least one end disc arranged on the front face of the filter body that seals the filter material,
an inner frame arranged on an interior peripheral surface, at least on of a supporting structure and a supporting grid, of the filter body, and
wherein an interior diameter of the end disc is at least as large as an interior diameter of the inner frame so that the inner frame is not covered radially inwardly by a sealing material of the end disc.

2. The ring filter element as specified in claim 1, wherein the inner frame overlaps the filter body in an axial direction and is embedded in an axial sealing contour of an axial sealing.

3. The ring filter element as specified in claim 1, wherein the inner frame includes a radial step on an axial end side of the filter body.

4. The ring filter element as specified in claim 3, wherein the inner frame includes a ring that axially protrudes over the filter body, said ring being part of the radial step and is embedded in an annular sealing lip of an axial sealing.

5. The ring filter element as specified in claim 4, wherein the ring, which axially protrudes over the filter body of the radial step, has a larger diameter than an interior diameter of the filter body.

6. The ring filter element as specified in claim 1, wherein the inner frame is completely enclosed by a sealing material of an axial sealing in its region that overlaps the filter body in an axial direction.

7. The ring filter element as specified in claim 1, wherein the sealing material of the end disc and of the axial sealing is plastic, in particular polyurethane.

8. (canceled)

9. The ring filter element as specified in claim 2, wherein the inner frame includes a radial step on an axial end side of the filter body.

10. The ring filter element as specified in claim 2, wherein the inner frame is completely enclosed by a sealing material if the axial sealing in its region that overlaps the filter body in the axial direction.

11. The ring filter element as specified in claim 2, wherein the sealing material of the end disc and of the axial sealing is plastic, in particular polyurethane.

12. The ring filter element as specified in claim 3, wherein the inner frame is completely enclosed by a sealing material if the axial sealing in its region that overlaps the filter body in the axial direction.

13. The ring filter element as specified in claim 3, wherein the sealing material of the end disc and of the axial sealing is plastic, in particular polyurethane.

14. The ring filter element as specified in claim 4, wherein the inner frame is completely enclosed by a sealing material of the axial sealing in its region that overlaps the filter body in the axial direction.

15. The ring filter element as specified in claim 4, wherein the sealing material of the end disc and of the axial sealing is plastic, in particular polyurethane.

16. The ring filter element as specified in claim 5, wherein the inner frame is completely enclosed by a sealing material of the axial sealing in its region that overlaps the filter body in the axial direction.

17. The ring filter element as specified in claim 5, wherein the sealing material of the end disc and of the axial sealing is plastic, in particular polyurethane.

18. The ring filter element as specified in claim 6, wherein the sealing material of the end disc and of the axial sealing is plastic, in particular polyurethane.
